(19) United States
(12) Patent Application Publication
(10) Pub. No.: US 2014/0160762 A1
(43) Pub. Date: Jun. 12, 2014

(54) DIFFUSER ELEMENT AND LIGHTING DEVICE COMPRISED THEREOF

(71) Applicant: GE LIGHTING SOLUTIONS, LLC, East Cleveland, OH (US)

(72) Inventors: David C. Dudik, Shaker Heights, OH (US); Charles Leigh Huddleston, Cleveland, OH (US); Benjamin Lee Yoder, Cleveland Heights, OH (US)

(73) Assignee: GE LIGHTING SOLUTIONS, LLC, East Cleveland, OH (US)

(21) Appl. No.: 13/708,797

(22) Filed: Dec. 7, 2012

(51) Int. Cl. F21V 3/04; F21V 29/00; G02B 5/02

(52) U.S. Cl. CPC F21V 3/049; G02B 5/0278; F21V 29/004
USPC 362/294; 359/599; 362/311.06

(57) ABSTRACT

This disclosure contemplates embodiments of a diffuser element for use with lighting devices that utilize directional light sources, e.g., light-emitting diode (LED) devices. The embodiments utilize a shell wall that forms a volume diffuser with a non-uniform material thickness. The variations in the thickness afford the diffuser with optical characteristics that can improve the distribution of light. In one example, lighting devices that deploy the diffuser element and LED devices distribute light with an optical intensity distribution similar to an incandescent bulb.

### BACKGROUND

The subject matter of the present disclosure relates to the illumination arts, lighting arts, solid-state lighting arts, and related arts.

Various types of incandescent lamps (e.g., integral incandescent lamps and halogen lamps) mate with a lamp socket via a threaded base connector (sometimes referred to as an “Edison base” in the context of an incandescent light bulb), a bayonet-type base connector (e.g., a bayonet base in the case of an incandescent light bulb), or other standard base connector. These lamps often form a unitary package, which includes components to operate from standard electrical power (e.g., 110 V and/or 220 V AC and/or 12 VDC). In the case of incandescent and halogen lamps, these components are minimal, as the lamp comprises an incandescent filament that operates at high temperature and efficiently radiates excess heat into the ambient. Many incandescent lamps are omni-directional light sources. These types of lamps provide light of substantially uniform optical intensity distribution (or, “intensity distribution”). Such lamps find diverse applications such as in desk lamps, table lamps, decorative lamps, chandeliers, ceiling fixtures, and other applications where a uniform distribution of light in all directions is desired.

The performance of solid-state lighting technologies (e.g., light-emitting diode (LED) devices) is often superior to incandescent lamps in terms of, for example, useful lifetime (e.g., lumen maintenance and reliability over time) and higher efficacy (e.g., Lumens per Electrical Watt (LPW)). Whereas the lifetime of incandescent lamps is typically in the range of about 1000 to 5000 hours, lighting devices that use LED devices can operate in excess of 25,000 hours, and perhaps as much as 100,000 hours or more. In terms of efficacy, incandescent and halogen lamps are typically in the range of 10-30 LPW, while lamps with LED devices can have efficacy of 40-100 LPW with anticipated improvements that will raise efficacy even higher in the future.

However, LED devices typically are highly directional by nature. Common LED devices are flat and emit light from only one side. Thus, although superior in performance, many commercially-available LED lamps cannot achieve intensity distribution of incandescent lamps.

Moreover, lamps that use solid-state technology must be equipped to adequately dissipate heat. LED devices are highly temperature-sensitive in both performance and reliability as compared with incandescent or halogen filaments. These sensitivities are often addressed by placing a heat sink in contact, or in thermal contact, with the LED device. However, the heat sink may block light that the LED device emits and hence further limits the ability to generate light of uniform intensity distribution. Physical constraints such as regulatory limits that define maximum dimensions for all lamp components, including light sources, further limit that ability to properly dissipate heat.

### BRIEF DESCRIPTION OF THE INVENTION

The present disclosure describes, in one embodiment, a diffuser element for use in a lighting device. The diffuser element includes a shell wall with a top, a bottom, an inner surface, an outer surface, and a center axis. The shell wall has a first thickness region and a second thickness region, each proximate a transition plane substantially perpendicular to the center axis and intersecting points on the outer surface at which the shell wall has a maximum diameter. The first thickness region and the second thickness region define, respectively, a first thickness and a second thickness that is different from the first thickness.

The present disclosure also describes, in one embodiment, a lighting device that comprises a light source and a diffuser element configured to receive light from the light source. The diffuser element has a first thickness region and a second thickness region, each proximate a transition plane substantially perpendicular to a center axis and intersecting points on the outer surface at which the diffuser element has a maximum diameter. The first thickness region and the second thickness region defining, respectively, a first thickness and a second thickness that is different from the first thickness.

The present disclosure further describes, in one embodiment, a lighting device that comprises a light source and a heat transfer assembly in thermal contact with the light source. The heat transfer assembly comprises a plurality of heat dissipating elements disposed circumferentially about a center axis. The lighting device also comprise a diffuser element disposed to receive light from the light source. The diffuser element comprises a top, a bottom, an outer surface, and an inner surface with a profile comprising a first arc and a second arc that is different from the first arc, the first arc and the second arc having a common tangent spaced apart from a transition plane substantially perpendicular to the center axis and intersecting points on the outer surface at which the diffuser element has a maximum diameter.

Other features and advantages of the disclosure will become apparent by reference to the following description taken in connection with the accompanying drawings.

### BRIEF DESCRIPTION OF THE DRAWINGS

Reference is now made briefly to the accompanying drawings, in which:

FIG. 1 depicts a side, cross-section of an exemplary embodiment of a diffuser element for use in a lighting device;

FIG. 2 depicts the diffuser element of FIG. 1 to discuss the geometry of the outer surface of the diffuser element;

FIG. 3 depicts the diffuser element of FIG. 1 to discuss the geometry of the inner surface of the diffuser element;

FIG. 4 depicts a side, cross-section view of an exemplary embodiment of a diffuser element in position on a lighting device;

FIG. 5 depicts in schematic form a ray-tracing diagram for an exemplary embodiment of a diffuser element on a lighting device; and

FIG. 6 depicts a plot of optical intensity distribution consistent with an exemplary embodiment of a diffuser element for use on a lighting device.

Where applicable like reference characters designate identical or corresponding components and units throughout the several views, which are not to scale unless otherwise indicated.

### DETAILED DESCRIPTION

Broadly, the discussion below describes improvements to lighting devices and, in one implementation, lighting devices that deploy directional light sources, e.g., light-emitting diode (LED) devices. The improvements focus on construction of a diffuser element that can disperse light from the light sources to generate a light intensity pattern similar to incandescent light sources. In one embodiment, the diffuser element includes a shell (also “shell wall”) that utilizes materials with volume scattering properties. Examples of these materials include polymers (e.g., polycarbonate) with reflective scattering particles (e.g., TiO₂) dispersed throughout. These materials afford the proposed diffuser elements with near-Lambertian scattering and low optical absorption. By varying the thickness of the shell wall to adjust and/or optimize the scattering and absorption, embodiments of the diffuser elements of this disclosure can replace conventional diffusers that use coatings (e.g., e-coat) that have Lambertian and/or near-Lambertian scattering properties, effectively eliminating and/or reducing the need for coatings and other post-processing techniques to reduce the cost and complexity of the diffuser element.

In one aspect, embodiments of the diffuser element of this disclosure embody a volume diffuser, rather than the more conventional surface diffuser that utilizes the surface coatings that concentrate light diffusion at the surface of the diffuser. Polymer-based volume diffusers at nominal thicknesses, however, are less diffusing than surface diffusers that have well-applied scattering coatings (e.g., e-coat). For example, increasing the thickness of the shell wall in these types of volume diffusers would generally increase absorption very quickly. As a result, simply increasing the thickness of the shell wall until all interior surfaces of the shell wall exhibit approximately Lambertian scattering would yield a part with an unacceptable amount of absorption. To reduce absorption and promote effective scattering, this disclosure proposes diffuser elements that vary the thickness throughout the shell wall to compensate for the non-Lambertian scattering of the material (e.g., the volume-diffusing polymer) while allowing the diffuser element to maintain a pre-defined outer shape that fits the profile, e.g., for incandescent lamps. Additionally, the varying thickness throughout the shell wall can also compensate for the impact of light that is reflected or absorbed by heat dissipating elements, which often surround the diffuser element to ensure appropriate heat dissipation.

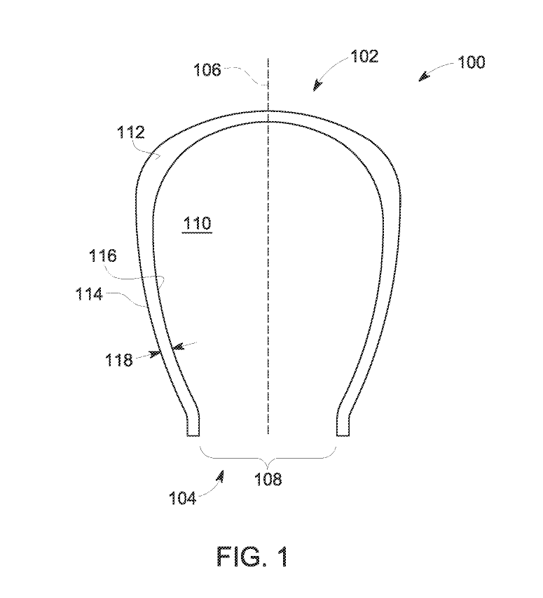

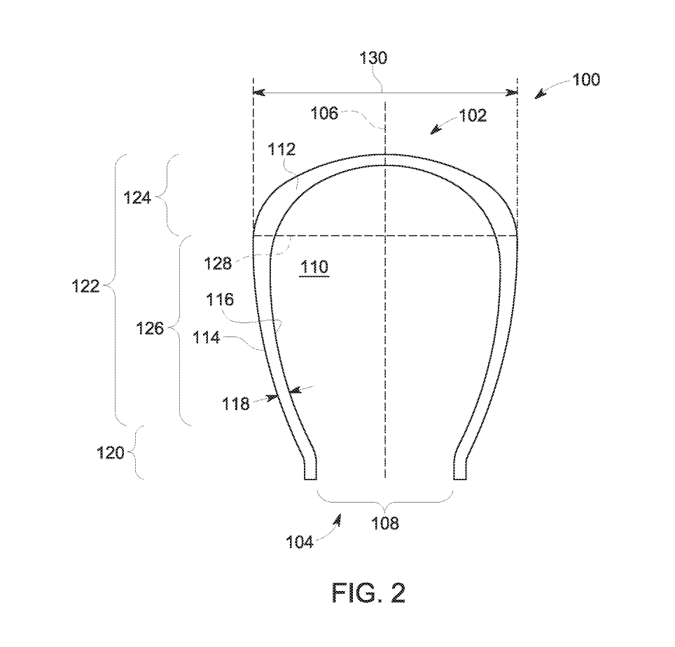

FIGS. 1, 2, and 3 illustrate an exemplary embodiment of a diffuser element 100 that utilizes variations in material thickness to achieve favorable light distribution. In FIG. 1 and FIG. 2, the diffuser element 100 has a top 102, a bottom 104, and a center axis 106. The diffuser element 100 also has an opening 108 that provides access to an interior volume 110. In one embodiment, construction of the diffuser element 100 comprises a shell wall 112 that revolves around the center axis 106 to form the open end 108 and the interior volume 110. The shell wall 112 has an outer surface 114 and an inner surface 116. A material thickness 118 defines the thickness of the shell wall 112 between the outer surface 114 and the inner surface 116.

Embodiments of the diffuser element 100 can replace glass optics found on many existing lamps and lighting devices that deploy light-emitting diode (LED) devices. These embodiments can comprise one or more types of bulk diffusive materials, e.g., polycarbonates. These materials may comprise light scattering and/or reflective light scattering particles mixed within the bulk diffusive material. In one example, these particles comprise titanium oxide (TiO₂). Exemplary materials can comprise Teijin ML4120, Teijin ML5206, and/or Teijin ML6110 polycarbonate. These types of materials and particles, in combination with the geometry and thickness characteristics for the shell wall 112, permit the diffuser element 100 to retain the same and/or similar shape as the glass optics, while distributing light from the LED devices to meet and/or exceed the distribution characteristics of these existing lighting devices.

Referring now to FIG. 2, the shell wall 112 can have a neck portion 120 at the bottom 104 and a body portion 122 that comprises the remaining portion of the diffuser element 100. The neck portion 120 incorporates the opening 108. The body portion 122 can include a number of contour regions (e.g., a first region 124 and a second region 126) that define the shape of the exterior of the diffuser element 100. A transition plane 128 delineates the transition that occurs as the shape of the diffuser element changes between the first region 124 and the second region 126. The transition plane 128 is perpendicular to the center axis 106 and extends through points on the outer surface 114 at which the diffuser element 100 has a maximum diameter 130.

The diffuser element 100 can incorporate a variety of shapes that, in conjunction with the thickness feature, can generate the desired light distribution. These shapes can include one or more of an oblate spheroid geometry and a prolate spheroid geometry, although this disclosure can include other shapes (e.g., spherical and elliptical designs). In one embodiment, the first region 124 can have a first shape geometry and the second region 126 can have a second shape geometry, wherein the first shape geometry is different from the second shape geometry. As shown in FIG. 2, the diffuser element 100 incorporates a generally prolate spheroid geometry in the first region 124 and a generally oblate spheroid geometry in the second region 126.

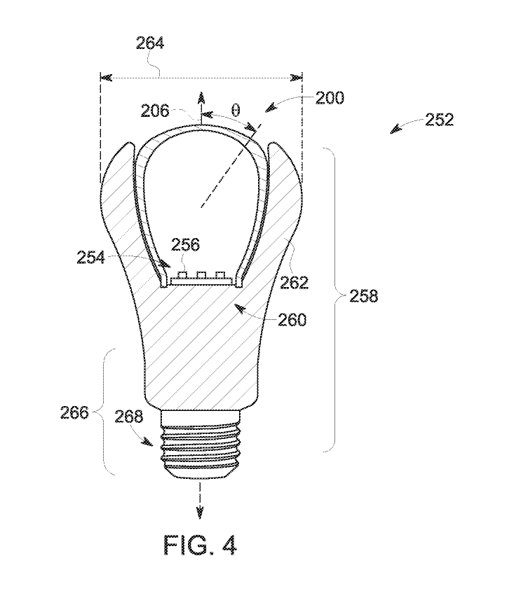

The neck portion 120 provides an interface with a lighting device, as shown in the diagram of FIG. 4 below. In the neck portion 120, embodiments of the diffuser element 100 can have a generally upwardly extending part of the shell wall 112. This upwardly extending part often does not receive any light, and thus the optical properties of the neck portion 120 may not be critical to achieve the appropriate distribution. Nonetheless, in one embodiment, the neck portion 120 comprises the same material and/or material properties as the body portion 122.

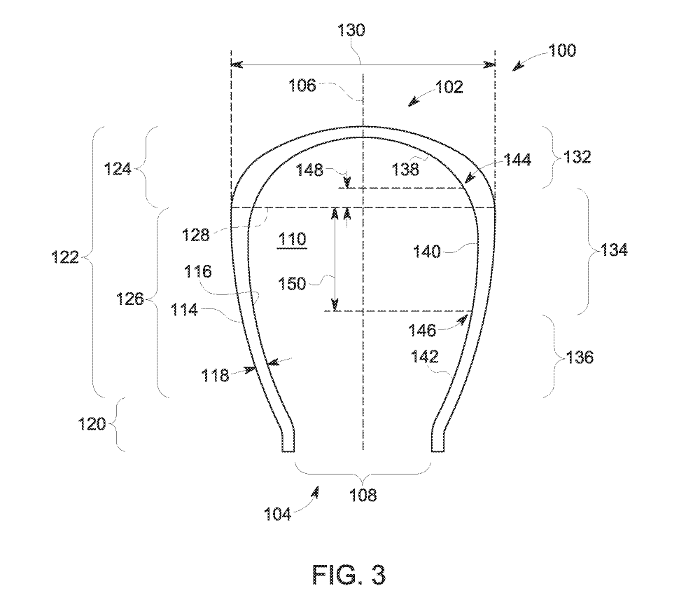

As best shown in FIG. 3, the body portion 122 also includes a number of thickness regions (e.g., a first thickness region 132, a second thickness region 134, and a third thickness region 136). The thickness regions 132, 134, 136 correspond to the profile of the inner surface 116. In one example, the profile comprises a plurality of arcs (e.g., a first arc 138, a second arc 140, and a third arc 142). One or more of the arcs 138, 140, 142 can share a common tangent (e.g., a first common tangent 144 and a second common tangent 146), which in one example describes a point (and/or a plurality of points) where a first adjacent arc and a second adjacent arc touch and/or intersect and where a first tangent to the first adjacent arc at the point and a second tangent to the second adjacent arc at the point have the same slope. This feature of the arcs 138, 140, 142 permits continuous curvature of the profile of the inner surface 116 as the first arc 138 transitions to the second arc 140 at the first common tangent 144 and the second arc 140 transitions to the third arc 142 at the second common tangent 146. In one embodiment, the common tangents 144, 146 correspond to, respectively, the location proximate where the first thickness region 132 transitions to the second thickness region 134 and the location proximate where the second thickness region 134 transitions to the third thickness region 136. As shown in FIG. 3, the common tangents 144, 146 can be spaced a distance (e.g., a first distance 148 and a second distance 150) from the transition plane 128.

The material thickness 118 can vary among and within the thickness regions 132, 134, 136. Moving from the top 102 to the bottom 104, in one embodiment, the material thickness 118 increases within the first thickness region 132, reaches a maximum value and then decreases in the second thickness region 134, and remains constant (e.g., within acceptable tolerances) in the third thickness region 136. The thickness can change by about 50% from the nominal thickness of the shell wall 112 to the maximum thickness, e.g., in the second thickness region 134. In one example, the thickness of the shell wall 112 varies within a range of about 1 mm to about 2.5 mm.

As set forth above, the profile of the inner surface 116 can define the material thickness of the shell wall 112. In one embodiment, the profile of the outer surface 116, e.g., as defined by shapes and geometry in the first region 124 and the second region 126 can remain constant and, in one or more constructions, are dimensionally constrained by an exterior profile dimension. Variations in the profile of the inner surface 116 can, however, modify the thickness of the shell wall 112 to form the various thickness regions 132, 134, 136.

The variations in the profile of the inner surface 116 may depend on features of the arcs 138, 140, 142. These features include, for example, the radii and/or the location of the center point, e.g., with respect to one or more of the center axis 106 and/or the transition plane. In one embodiment, the first arc 138 has a first radius, the second arc 140 has a second radius, and the third arc 142 has a third radius. One or more of the first radius, the second radius, and the third radius may be different from the other radii. Moreover, in one example, the first radius, the second radius, and the third radius have different values, i.e., the first radius is different from the second radius and the second radius is different from the third radius.

The location of the center point of the arcs 138, 140, 142 can also vary and, thus, work in combination with the values of the radii corresponding with the arcs 138, 140, 142 to define the profile of the inner surface 116. In one embodiment, the center point of the first arc 138 can be disposed at the intersection of the center axis 106 and the transition plane 128, wherein the value of the first radius causes the first arc 138 to have negative concavity, as shown in FIGS. 1, 2, and 3. The center point of the second arc 140 can be disposed below the transition plane 128 and displaced from the center axis 106 (e.g., to the left of the center axis 106 with reference to FIGS. 1, 2, and 3), wherein the value of the second radius causes the second arc 140 to have negative concavity, as shown in FIGS. 1, 2, and 3. The center point of the third arc 142 can be disposed on the transition plane 128 and displaced from the center axis 106 (e.g., to the left of the center axis 106 with reference to FIGS. 1, 2, and 3), wherein the value of the third radius causes the third arc 142 to have positive concavity, as shown in FIGS. 1, 2, and 3. As used herein, the terms positive concavity and negative concavity describe the second derivative of the mathematical function that define the arcs 138, 140, 142.

FIG. 4 illustrates a side, cross-section view of an exemplary embodiment of a diffuser element 200 that has a non-uniform thickness as discussed above. The diffuser element 200 fits in a lighting device 252, e.g., a high-efficiency lighting device and/or lighting device. The lighting device 252 has a light source 254 with one or more light-emitting diode (LED) devices 256 that generate light. The lighting device 252 also has a base assembly 258 that supports the diffuser element 200 and the light source 254. The base assembly 258 includes a base element 260 (e.g., a heat sink) and one or more heat dissipating elements 262 (e.g., fins) that couple with the base element 260. In one example, the diffuser element 200 is disposed interior to the heat dissipating elements 262. This configuration gives the heat dissipating elements 262 an appearance on the lighting device 252 similar to an architectural “buttress.” The heat dissipating elements 262 fit within a lighting device profile 264, which defines the outer boundaries of the structure of the lighting device 252. Together, the elements 260, 262 dissipate heat from the light source 254 to the environment surrounding the lighting device 252.

The base assembly 258 also includes a body 266 that terminates at a connector 268. The body 266 and the connector 268 can house a variety of electrical components and circuitry that drive and control the light source 254. Alternatively, electrical components and circuitry can be housed, in part or in whole, in a housing (not shown) placed generally between 258 and 268. Examples of the connector 268 are compatible with Edison-type lamp sockets found in U.S. residential and office premises as well as other types of sockets and connectors that conduct electricity to the components of the lamp 252.

The diagram of FIG. 4 includes a coordinate system with the center axis 206 that defines an elevation or latitude coordinate θ in the far field (also “distribution angle θ”). This coordinate system is useful to describe the spatial distribution of illumination common to intensity distribution and, in particular, to describe the benefits of examples of the diffuser element 200. In one example, use of the diffuser element 200 makes the lighting device 252 a favorable substitute, e.g., for incandescent bulbs, because the lighting device 252 uses much less energy and provides adequate thermal dissipation to maintain operation of the LED devices 106 well beyond the operating life of incandescent bulbs. Furthermore, the lighting device 252 fits within the lighting device profile 264 that meet various industry standards including ANSI and IEC standards. This feature makes the lighting device 252 suitable for use as a replacement for a variety of incandescent light bulbs including A-type (e.g., A15, A19, A21, A23, etc.), G-type (e.g., G20, G30, etc.), as well as other profiles that various industry standards known and recognized in the art define. In one example, the lighting device profile 264 has a value in the range of about 60 mm (e.g., typical of a GE A19 incandescent lamp) to about 69.5 mm (e.g., the maximum diameter allowed by ANSI for an A19 lamp). Artisans having skill in the relevant lighting arts can scale the dimensions of the lighting device profile and the diffuser element 200 to meet the dimensional specifications for the other A-line and G-type sizes.

In operation, light from the light source 254 travels directionally toward the top of the diffuser element 200 along the center axis 206 much more strongly than in any other direction. The diffuser element 200 exhibits optical properties to generate intensity distributions having uniformity of ±20% at distribution angles θ in the range of 0° to 135° or greater relative to the center axis 206 despite the directionality of the light from the light source 254. The diffuser element 200 can direct light downwardly at distribution angles θ of 90° or more, reaching in one example from 135° to 150° and, in another example, up to 150° or more. The reflected light transmits through the diffuser element 200. To promote effective intensity distribution of light, the shape and location of the heat dissipating elements 262 reduce interference with the transmitting light.

In view of the foregoing, the disclosure now focuses on various design features of the embodiments of the diffuser elements 100, 200 and examples of the lighting device comprised thereof.

The diffuser elements 100, 200 can be substantially hollow and have a curvilinear outer geometry, e.g., spherical, spheroidal, ellipsoidal, toroidal, ovoidal, etc., that diffuses light. In some embodiments, the diffuser elements can comprise a glass element, although this disclosure contemplates a variety of light-transmissive material such as diffusive plastics (e.g., diffusing polycarbonate) and other commercially-available diffusing polymers (e.g., Teijin ML4120, ML5206, ML6110, Bayer MAKROLON®, etc.) that diffuse light. Materials of the diffuser elements may be inherently light-diffusive (e.g., opal glass) or can be made light-diffusive in various ways such as by frosting and/or other texturing of the inside surface (e.g., the inner surface 116) and/or the outer surface (e.g., the outer surface 114) to promote light diffusion. In one example, the diffuser element comprises a coating (not shown) such as enamel paint and/or other light-diffusive coating. Suitable types of coatings are found on glass bulbs of some incandescent or fluorescent light bulbs. In still other examples, manufacturing techniques may embed light-scattering particles or fibers or other light scattering media in the material of the diffuser elements.

The diffuser elements can form the light into a light intensity distribution pattern (also “intensity distribution”) of scope comparable to the intensity distribution of conventional incandescent light bulbs. However, as discussed further below, the non-uniform thickness of the diffuser elements may eliminate the need for coatings and/or other materials that are found on conventional diffuser elements and transmissive elements for use with high-efficiency lighting devices. The thickness feature also simplifies construction of the diffuser element 100. For example, the diffuser elements comport with manufacturing techniques (e.g., molding, casting, etc.) that form the diffuser elements as a single, unitary structure. These techniques can eliminate cost and simplify manufacturing processes, e.g., by providing a simple, yet robust light-transmissive element that permits use of cost-effective lighting sources (e.g., LEDs) to achieve intensity distributions of conventional incandescent lighting devices.

Variations in the shape can influence the intensity distribution the diffuser element 100 exhibits, e.g., by defining the features of spheroid geometry. The shape may, for example, incorporate generally flatter shapes than a sphere, e.g., having a shape of an oblate spheroid, thus the diffuser elements will have a flattened (or substantially flattened) top and peripheral radial curvatures as shown in FIGS. 1, 2, and 3. However, the present disclosure also contemplates configurations in which the diffuser elements can deviate from an oblate spheroid, e.g., to a sphere, a prolate spheroid, a cone or conical shape, as well as other hollow configuration that can favorably change the distribution of light that is reflected and/or diffused to generate favorable intensity distributions.

Embodiments of the diffuser elements may be formed monolithically as a single unitary construction or as components that are affixed together. Materials, desired optical properties, and other factors (e.g., cost) may dictate the type of construction necessary to form the geometry (e.g., the spheroid geometry) of the diffuser elements.

Thermal properties of the dissipating elements (e.g., elements 262) can have a significant effect on the total energy that the lighting devices dissipate and, accordingly, the operating temperature of the light source (e.g., the light source 254) and any corresponding driver electronics. Since operating temperature can limit the performance and reliability of the light source and driver electronics, it is critical to select one or more materials for use in the lighting device with appropriate properties. The thermal conductivity of a material defines the ability of a material to conduct heat. When used in context of a component, the thermal conductivity of the material in components, along with the dimensions and/or characteristics (e.g., shape) of the components, defines the thermal conductance of the component, which is the ability of the component to conduct heat. Since the light source may have a very high heat flux density, the lighting devices should preferably comprise materials with high thermal conductivity, and components having dimensions providing high thermal conductance so that the generated heat can be conducted through a low thermal resistance (i.e., the inverse of thermal conductance) away from the light source.

Examples of the heat dissipating elements 262 can also have optical properties that affect the resultant optical intensity. When light impinges on a surface, it can be absorbed, transmitted, or reflected. In the case of most engineering thermal materials, they are opaque to visible light, and hence, visible light can be absorbed or reflected from the surface. In consideration of optical properties, selection and design of the lighting devices should contemplate the optical reflectivity efficiency, optical specularity, and the size and location of the heat dissipating elements. As discussed hereinbelow, concerns of optical efficiency, optical reflectivity, and intensity will refer herein to the efficiency and reflectivity of the wavelength range of visible light, typically about 400 nm to about 700 nm.

The optical intensity is affected by both the redirection of emitted light from the light source and also absorption of flux by the heat dissipating elements. In one embodiment, if the reflectivity of the heat dissipating elements is kept at a high level, such as greater than 70%, the distortions in the optical intensity can be minimized. Similarly, the longitudinal and latitudinal intensity distributions can be affected by the surface finish of the thermal heat sink and surface enhancing elements. Smooth surfaces with a high specularity (mirror-like) distort the underlying intensity distribution less than diffuse (Lambertian) surfaces as the light is directed outward along the incident angle rather than perpendicular to the surface of the heat dissipating elements.

A range of surface finishes, varying from a specular (reflective) to a diffuse (Lambertian) surface can be selected for the heat dissipating elements 242. The specular designs can be a reflective base material or an applied highly specular coating. The diffuse surface can be a finish on the heat dissipating elements, or an applied paint or powder coating or foam or fiber mat or other diffuse coating. Each provides certain advantages and disadvantages. For example, a highly reflective surface may have the ability to maintain the light intensity distribution, but may be thermally disadvantageous due to the generally lower emissivity of bare metal surfaces. Or a highly diffuse, high-reflectivity coating may require a thickness that provides a thermally insulating barrier between the heat dissipating elements and the ambient air.

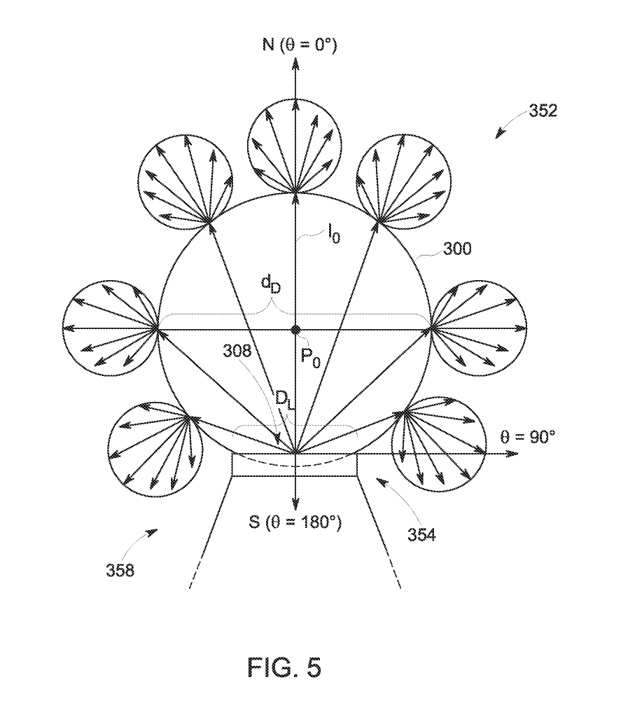

The heat dissipation by convection and radiation can also be enhanced by increasing the surface area of the heat sink. Examples of the lighting device 252 may comprise 3 or more of the heat dissipating elements arranged radially about the center axis (e.g., the center axis 206). The heat dissipating elements can be equally spaced from one another so that adjacent ones of the heat dissipating elements are separated by at least about 45° for an 8-element arrangement and 22.5° for a 16-element arrangement. Physical dimensions (e.g., width, thickness, and height) can also determine the necessary separation between the dissipating elements 262. For example, when used in conjunction with the multi-component diffuser element, the position of the heat dissipating elements may align with certain elements and locations that optimize the intensity distribution of light through the diffuser elements. These heat dissipation elements 262 can be added to the base, but these may interfere with the light output if they extend outward beyond a blocking angle α_{B}, which is described in connection with FIG. 5 further below.

Exemplary light sources (e.g., light source 254) can comprise a planar LED-based light source that emits light having a nearly Lambertian intensity distribution, compatible with exemplary diffuser elements for producing omni-directional illumination distribution. In one embodiment, the planar LED-based Lambertian light source includes a plurality of LED devices (e.g., LED devices 256) mounted on a circuit board (not shown), which is optionally a metal core printed circuit board (MCPCB). The LED devices may comprise different types of LEDs. For example, exemplary light engines may comprise one or more first LED devices and one or more second LED devices having respective spectra and intensities that mix to render white light of a desired color temperature and color rendering index (CRI). In one embodiment, the first LED devices output white light, which in one example has a greenish rendition (achievable, for example, by using a blue- or violet-emitting LED chip that is coated with a suitable “white” phosphor). The second LED devices output red and/or orange light (achievable, for example, using a GaAsP or AlGaInP or other epitaxy LED chip that naturally emits red and/or orange light, or by selecting a phosphor that emits red or orange light). The light from the first LED devices and second LED devices blend together to produce improved color rendition. In another embodiment, the planar LED-based Lambertian light source can also comprise a single LED device or an array of LED emitters incorporated into a single LED device, which may be a white LED device and/or a saturated color LED device and/or so forth. In another embodiment, the LED emitters are organic LEDs comprising, in one example, organic compounds that emit light.

The discussion below provides additional information to describe additional embodiments and/or configurations of the diffuser elements and exemplary lighting devices contemplated herein.

FIG. 5 illustrates a schematic diagram of another diffuser element 300 with an opening 308 that is part of a lighting device 352 that generates omni-directional illumination over an elevational or latitudinal angle θ in a range substantially greater than 0° to 90°. Two points are recognized herein. First, with the planar LED-based Lambertian light source 354 placed tangentially to the diffuser element 400, the Lambertian illumination output by the planar LED-based Lambertian light source 354 is uniform over the entire (inside) surface of the spherical diffuser element 300. In other words, the flux (lumens/area), typically measured in units of lux (lumens/m²), of light shining on the (inside) surface of the diffuser element 300 is of the same value at any point on the diffuser element 300. Thus, the inside surface of the diffuser element 300 coincides with an isolux surface of the LED light source.

Qualitatively, the forward-directed beam of the Lambertian light source has a maximum value Iₒ at θ=0°; however, this forward-directed portion of the beam having intensity Iₒ also travels the furthest before impinging on the (inside) surface of the diffuser element 300. The intensity decreases with the square of distance, and so the intensity is proportional to Iₒ/d_{D}² (where exact tangency of the light source 354 and the curvature of the diffuser element 300 is here assumed as a simplification). At an arbitrary latitude angle θ, the intensity from the source is lower, namely Iₒ cos(θ); however, the distance traveled d=d_{D} cos(θ) before impinging on the diffuser element 300 is lower by an amount cos(θ) and the projected surface area on which the intensity is received at the spherical diffuser element is also reduced by the factor cos(θ). Thus, the flux density at the surface at any latitude angle θ is proportional to (Iₒ cos(θ)cos(θ))/(d_{D} cos(θ))²=constant, which is the same as at θ=0. Thus, for the case of a Lambertian intensity distribution emitted by the LED light source, the inside surface of a diffuser element having the LEDs positioned tangentially on the surface of the diffuser element is coincident with an isolux contour surface of the intensity distribution of the light source 354.

In general, distortions from an ideally spherical (Lambertian) distribution may be described as a spheroidal shape, such as an elongated prolate spheroidal distribution or a flattened oblate spheroidal distribution shown in connection with the diffuser elements 100, 200 of FIGS. 1, 2, 3, and 4. Even more generally, it will be appreciated that substantially any light source illumination distribution can be similarly accommodated, by choosing a diffuser element whose surface corresponds with an isolux surface of the light source. Indeed, variation in the azimuthal or longitudinal direction can be accommodated in this same way, by accounting for the variation in the azimuthal or longitudinal direction in defining the isolux surface. As previously noted, the light distribution can also be affected by secondary factors such as reflection from the base. Such secondary distortions can be accommodated by adjustments of the diffuser element shape. In some embodiments, for example, the light distribution pattern generated by the light source may be Lambertian with very slight prolate distortion, but in view of the secondary affect of base reflection a spherical diffuser element with a slight oblate shape distortion may be selected as providing the optimal lighting device intensity distribution.

The second point recognized herein is that the diffuser element 300 (assuming ideal light diffusion) emits a Lambertian (or near-Lambertian) light intensity distribution output at any point on its surface responsive to illumination inside the diffuser element 300 by the light source 354. In other words, the light intensity output at a point on the surface of the diffuser element 300 responsive to illumination inside the diffuser element 300 scales with cos(θ) where θ is the viewing angle respective to the diffuser element surface normal at that point. This is diagrammatically illustrated in FIG. 5 by showing the ray tracing diagrams for seven direct rays emitted by the planar LED-based Lambertian light source 354. At the point where each direct ray impinges on the surface of the light-transmissive spherical diffuser element 300, it is diffused into a Lambertian output emitted from the (outside) surface of the spherical diffuser element 300.

As is known in the optical arts, a surface emitting light in a Lambertian distribution appears to have the same intensity (or brightness) regardless of viewing angle because at larger viewing angles respective to the surface normal the Lambertian decrease in output intensity is precisely offset by the smaller perceived viewing area due to the oblique viewing angle. Since the entire surface of the diffuser element 300 is illuminated with the same intensity (the first point set forth in the immediately preceding paragraph) the result is that an outside viewer observes the diffuser element 300 to emit light with uniform intensity at all viewing angles, and with spatially uniform source brightness at the surface of the diffusing sphere.

As described previously, embodiments of the diffuser element 300, and other embodiments of the present disclosure, embody a volume diffuser, rather than the more conventional surface diffuser that utilizes the surface coatings that concentrate light diffusion at the surface of the diffuser. Polymer-based volume diffusers at nominal thicknesses, however, are less diffusing than surface diffusers that have well-applied scattering coatings (e.g., e-coat). These surface diffusers themselves often exhibit less than true Lambertian scattering. The farther the diffuser material is from exhibiting the Lambertian scattering described in the foregoing analysis, the more the inside surface of the diffuser element must deviate from the ideal isolux contour in order to maintain the appropriate far-field intensity distribution. Embodiments of the diffuser elements of this disclosure allow both the general shape and the thickness of different regions of the shell wall to be tailored in order to minimize light absorption within the diffuser element itself, while still maintaining the appropriate light intensity distribution. Additionally, the varying thickness throughout the shell wall can compensate for the impact of light that is reflected or absorbed by heat dissipating elements surrounding the diffuser when employed in combination with or instead of changing the general shape of the diffuser element.

At the same time, embodiments of the diffuser element 300 can provide excellent color mixing characteristics through the light diffusion process, without the need for multiple bounces through additional optical elements, or the use of optical components that result in loss or absorption of the light. Still further, since the planar LED-based Lambertian light source 354 is designed to be small compared with the spherical diffuser element 10 (that is, the ratio d_{D}/d_{L} should be large) it follows that the backward light shadowing is greatly reduced as compared with existing designs employing hemispherical diffuser elements, in which the planar LED-based Lambertian light source 354 is placed at the equatorial plane θ=90° and has the same diameter as the hemispherical diffuser element (corresponding to the limit in which d_{D}/d_{L}=1).

The configuration of the base assembly 358 also contributes to providing omnidirectional illumination. Examples of the diffuser element 300 illuminated by the LED-based Lambertian light source 354 can be thought of from a far-field viewpoint as generating light emanating from a point P₀. In other words, a far-field point light source location P₀ is defined by the omnidirectional light assembly comprising the light source 354 and diffuser element 300. The base assembly 358 blocks some of the “backward”-directed light, so that a latitudinal blocking angle α_{B} can be defined by the largest latitude angle θ having direct line-of-sight to the point P₀. For viewing angles within the blocking angle α_{B}, the base assembly 358 provides substantial shadowing and a consequent large decrease in illumination intensity. It should be appreciated that the concept of the latitudinal blocking angle α_{B} is useful in the far field approximation, but is not an exact calculation, for example, in that a light ray R_{S} does illuminate within the region of the blocking angle α_{B}. The light ray R_{S} is present because of the finite size of the diffuser element 300 which is only approximated as a point light source P₀ at in the far field approximation. The base assembly 358 also reflects some of the backward-directed light, without blocking or absorbing it, and redirects that reflected light into the light distribution pattern of the lighting device, adding to the light distribution in the angular zone just above the blocking angle. To accommodate the effect on the light distribution pattern due to reflection of light from the surface of the heat sink and base, the shape of the diffuser element 300 may be altered slightly near the intersection of the diffuser element 300 and the light source 354 in order to improve the uniformity of the distribution pattern in that zone of angles.

In view of the foregoing, the omni-directionality of the illumination at large latitude angles is seen to be additionally dependent on the size and geometry of the base assembly 358 which controls the size of the blocking angle α_{B}. Although some illumination within the blocking angle α_{B} can be obtained by enlarging the diameter d_{D} of the diffuser element 300 (for example, as explained with reference to light ray R_{S}), this diameter is typically constrained by practical considerations. For example, if a retrofit incandescent light bulb is being designed, then the diameter d_{D} of the diffuser element 300 is constrained to be smaller than or (at most) about the same size as the incandescent bulb being replaced. One suitable base design has sides angled to substantially conform with the blocking angle α_{B}. A base design having sides angled at about the blocking angle α_{B} provides the largest base volume for that blocking angle α_{B}, which in turn provides the largest volume for electronics and heat sinking mass.

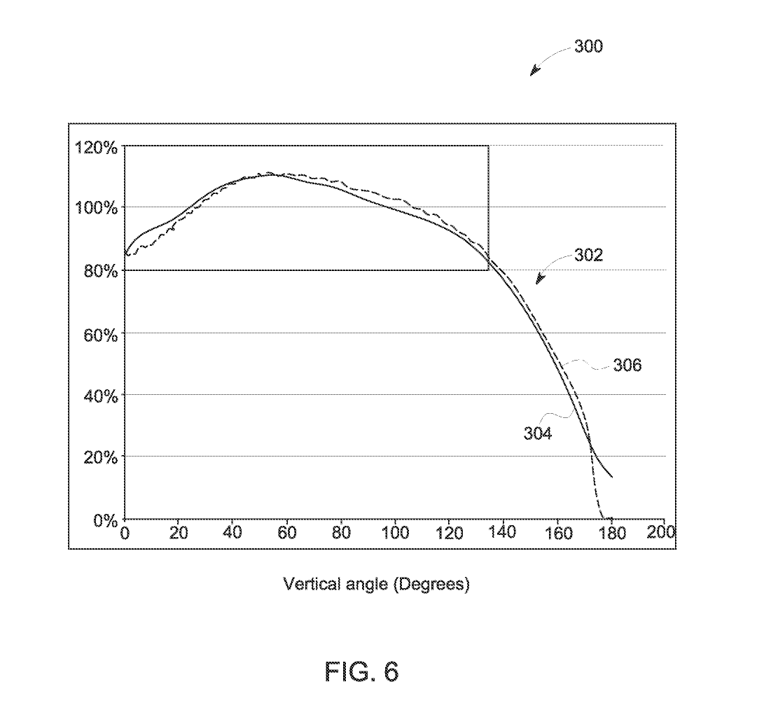

FIG. 6 illustrates a plot 300 of an optical intensity distribution profile 302 (or “optical intensity” profile 302) that compares an optical simulation (i.e., line 304) with an exemplary diffuser element (i.e., line 306) having features of an embodiment of a diffuser element (e.g., diffuser element 100, 200 of FIGS. 1, 2, 3, and 4) described above. Data for the line 306 was gathered using a Mirror Goniometer. As the line 306 illustrates, the exemplary diffuser element achieves a mean optical intensity of about 100±20% at an angle (e.g., the latitude coordinate θ of FIG. 4) up to at least 135°.

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features.

This written description uses examples to disclose embodiments of the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A diffuser element for use in a lighting device, comprising:
a shell wall comprising a top, a bottom, an inner surface, an outer surface, and a center axis, the shell wall having a first thickness region and a second thickness region, each proximate a transition plane substantially perpendicular to the center axis and intersecting points on the outer surface at which the shell wall has a maximum diameter, the first thickness region and the second thickness region defining, respectively, a first thickness and a second thickness that is different from the first thickness.

2. The diffuser element of claim 1, wherein the first thickness region and the second thickness region correspond to a profile of the inner surface, the profile comprising a first arc and a second arc having a first common tangent at a transition of the first thickness region and the second thickness region.

3. The diffuser element of claim 2, wherein the first common tangent is spaced apart from the transition plane in a direction along the center axis towards the top of the shell wall.

4. The diffuser element of claim 1, wherein the shell wall comprises a polymer having light scattering particles dispersed therein.

5. The diffuser element of claim 4, wherein the light scattering particles comprise TiO₂.

6. The diffuser element of claim 1, wherein the outer surface defines a first shape and a second shape that is different from the first shape.

7. The diffuser element of claim 6, wherein one of the first shape and the second shape comprises a prolate spheroid geometry.

8. The diffuser element of claim 6, wherein one of the first shape and the second shape comprise an oblate spheroid geometry.

9. The diffuser element of claim 6, wherein the transition plane defines the boundary between the first shape and the second shape.

10. The diffuser element of claim 1, wherein the shell wall comprises a unitary structure.

11. A lighting device, comprising:
a light source; and
a diffuser element configured to receive light from the light source, the diffuser element having a first thickness region and a second thickness region, each proximate a transition plane substantially perpendicular to a center axis and intersecting points on the outer surface at which the diffuser element has a maximum diameter, the first thickness region and the second thickness region defining, respectively, a first thickness and a second thickness that is different from the first thickness.

12. The lighting device of claim 11, wherein the diffuser element comprises a polymer having light scattering particles dispersed therein.

13. The lighting device of claim 11, wherein the diffuser comprises a third thickness region having a third thickness that is different from the first thickness and the second thickness.

14. The lighting device of claim 13, wherein the first thickness region, the second thickness region, and the third thickness region correspond to a profile of the inner surface, wherein the profile comprises a first arc, a second arc, and a third arc, and wherein the first arc and the second arc have a first common tangent at a location where the first thickness region transitions to the second thickness region and the second arc and the third arc have a second common tangent at a location where the second thickness region transitions to the third thickness region.

15. The lighting device of claim 13, wherein the second thickness corresponds to a maximum thickness of the shell wall.

16. The lighting device of claim 11, wherein the diffuser has an outer surface forming a prolate spheroid geometry and an oblate spheroid shape separated by the transition plane.

17. A lighting device, comprising:
a light source;
a heat transfer assembly in thermal contact with the light source, the heat transfer assembly comprising a plurality of heat dissipating elements disposed circumferentially about a center axis; and
a diffuser element disposed to receive light from the light source, the diffuser element comprising a top, a bottom, an outer surface, and an inner surface with a profile comprising a first arc and a second arc that is different from the first arc, the first arc and the second arc having a common tangent spaced apart from a transition plane substantially perpendicular to the center axis and intersecting points on the outer surface at which the diffuser element has a maximum diameter.

18. The lighting device of claim 17, wherein the diffuser element is disposed interior to the heat dissipating elements.

19. The lighting device of claim 17, wherein the first arc defines a first material thickness for the diffuser and the second arc defines a second material thickness for the diffuser, and wherein the first material thickness is different from the second material thickness.

20. The lighting device of claim 17, wherein the common tangent is located on a side of the transition plane proximate the top of the diffuser.
